(19) United States
(12) Patent Application Publication
(10) Pub. No.: US 2026/0066340 A1
(43) Pub. Date: Mar. 5, 2026

(54) METHOD FOR PREPARING SOLID STATE ELECTROLYTE MEMBRANE STRUCTURE

(71) Applicant: MICROVAST, INC., Stafford, TX (US)

(72) Inventors: Huijie GUO, Huzhou (CN); Bryan Thomas Yonemoto, Stafford, TX (US)

(73) Assignee: MICROVAST, INC., Stafford, TX (US)

(21) Appl. No.: 18/822,018

(22) Filed: Aug. 30, 2024

(51) Int. Cl. H01M 10/0562; H01M 10/052

(52) U.S. Cl. CPC H01M 10/0562; H01M 10/052; H01M 2300/0071; H01M 2300/0094

(57) ABSTRACT

A method for preparing a solid-state electrolyte membrane structure. The method includes: S1, proportionally mixing raw materials of a solid-state electrolyte to obtain a mixed powder; S2, mixing the mixed powder, a binder and a solvent together to obtain a solid-state electrolyte precursor slurry; S3, coating the solid-state electrolyte precursor slurry on a substrate to obtain a solid-state electrolyte precursor coating layer; and S4, subjecting the solid-state electrolyte precursor coating layer to a laser treatment to obtain the solid-state electrolyte membrane structure.

### TECHNICAL FIELD

The present disclosure relates to the field of solid-state electrolyte technology, in particular, to a method for preparing a sloid-state electrolyte membrane structure.

### BACKGROUND

In related art, there are generally two kinds of methods for preparing a solid-state electrolyte membrane for a solid-state battery. One method includes: processing raw materials of the solid-state electrolyte membrane on a non-substrate (e.g., non-current collector or a non-electrode) to form the solid-state electrolyte membrane, and then stripping the solid-state electrolyte membrane to assemble a solid-state battery. It requires two or more steps to apply raw materials of the solid-state electrolyte in the battery, and the operation is complex. Another method includes: coating a solid-state electrolyte product on a current collector (or an electrode) to form a solid-state electrolyte product-coated current collector, and subjecting the solid-state electrolyte product-coated current collector to a laser treatment to prepare the solid-state electrolyte membrane structure, which has a high cost. The problem that should be solved by the skilled in the art is to find a new method that makes the method for preparing the solid electrolyte membranes simple, efficient and yet as cost effective as possible.

### SUMMARY

A method for preparing a solid-state electrolyte membrane structure is provided in conjunction with embodiments of the present disclosure.

A method for preparing a solid-state electrolyte membrane structure, including
step S1, proportionally mixing raw materials of a solid-state electrolyte to obtain a mixed powder;
step S2, mixing the mixed powder, a binder and a solvent together to obtain a solid-state electrolyte precursor slurry;
step S3, coating the solid-state electrolyte precursor slurry on a substrate to obtain a solid-state electrolyte precursor coating layer; and
step S4, subjecting the solid-state electrolyte precursor coating layer to a laser treatment to obtain the solid-state electrolyte membrane structure.

In some embodiments, the raw materials of the solid-state electrolyte includes a lithium source and a second metal source, and a second metal of the second metal source is selected from the group consisting of Al, Ti, Zr, La, Ta, Nb, and any combination thereof.

In some embodiments, the lithium source is selected from the group consisting of lithium salts, lithium oxide, lithium hydroxide, and any combination thereof; and the second metal source is selected from the group consisting of second metal salts, second metal oxide, second metal hydroxide, and any combination thereof.

In some embodiments, the lithium source is selected from the group consisting of Li₂SO₄, LiNO₃, LiCl, Li₂O, LiOH, and any combination thereof; and the second metal source is selected from the group consisting of Al₂O₃, TiO₂, ZrO₂, La₂O₃, Ta₂O₅, Nb₂O₅, La(NO₃)₃, and any combination thereof.

In some embodiments, the raw materials of the solid-state electrolyte further includes a phosphorus source, the phosphorus source includes a phosphate group, the phosphate group is selected from the group consisting of NH₄H₂PO₄, (NH₄)₃PO₄ (NH₄)₂HPO₄, and any combination thereof.

In some embodiments, in step S1, proportionally mixing raw materials of the solid-state electrolyte to obtain the mixed powder includes grinding the raw materials of the solid-state electrolyte to obtain the mixed powder, and an average particle size of the mixed powder is smaller than or equal to 300 nm.

In some embodiments, in step S2, a mass ratio of the binder to the mixed powder is in a range of 1:100 to 5:95, and the binder is selected from the group consisting of polyvinylidene difluoride, epoxy resin, aramid, polytetrafluoroethylene, and any combination thereof.

In some embodiments, in step S2, a viscosity of the solid-state electrolyte precursor slurry is in a range of 2000 cPs to 9000 cPs, and the solvent is selected from the group consisting of ethanol, acetone, N-methylpyrrolidone, isopropanol, ethyl acetate, dimethylacetamide, and any combination thereof.

In some embodiments, in step S3, the substrate includes a current collector or a electrode plate.

In some embodiments, in step S4, before the step of subjecting the solid-state electrolyte precursor coating layer to the laser treatment, the method further includes a step of subjecting the solid-state electrolyte precursor coating layer to a preheating treatment, a temperature of the preheating treatment is lower than a temperature at which the solid-state electrolyte precursor coating layer reacts chemically, and a temperature difference between the temperature of the preheating treatment and the temperature at which the solid-state electrolyte precursor coating layer reacts chemically is smaller than or equal to 400° C.

In some embodiments, the temperature of the preheating treatment is in a range of 400° C. to 800° C.

In some embodiments, the preheating treatment is a gradient preheating treatment.

In some embodiments, the gradient preheating treatment includes: heating the solid-state electrolyte precursor coating layer at a first heating rate in a range of 1° C./min to 20° C./min, and then heating the solid-state electrolyte precursor coating layer at a second heating rate in a range of 20° C./min to 50° C./min to the temperature of the preheating treatment.

In some embodiments, in step S4, after a temperature of the solid-state electrolyte precursor coating layer reaches the temperature of the preheating treatment, holding the solid-state electrolyte precursor coating layer for 1 minute to 10 minutes, and then subjecting the solid-state electrolyte precursor coating layer to the laser treatment.

In some embodiments, in step S4, before the step of subjecting the solid electrolyte precursor coating layer to the laser treatment, the method for preparing the solid-state electrolyte membrane structure further includes a step of drying the solid-state electrolyte precursor coating layer and applying a pressure to the solid-state electrolyte precursor coating layer.

In some embodiments, in step S4, before the step of subjecting the solid electrolyte precursor coating layer to the laser treatment, a porosity of the solid-state electrolyte precursor coating layer is in a range of 5% to 40%.

In some embodiments, in step S4, before the step of subjecting the solid electrolyte precursor coating layer to the laser treatment, a thickness of the solid-state electrolyte precursor coating layer is in a range of 5 um to 100 um.

In some embodiments, in step S4, a wavelength of a laser for the laser treatment is in a range of 900 nm to 1200 nm, and a power of the laser for the laser treatment is in a range of 20 W to 150 W.

In some embodiments, in step S4, the solid-state electrolyte structure includes the substrate and a solid-state electrolyte membrane fixed on the substrate. After the step of obtaining the solid-state electrolyte membrane structure, the method further includes repeating a step of coating the solid-state electrolyte precursor slurry on the solid-state electrolyte membrane to obtain the solid-state electrolyte precursor coating layer and a step of subjecting the solid-state electrolyte precursor coating layer to the laser treatment to accomplish a chemical reaction of the solid-state electrolyte precursor coating layer, so as to increase a thickness of the solid-state electrolyte membrane.

Details of one or more embodiments of the present application are presented in the following accompanying drawings and description in order to make other features, purposes and advantages of the present application more concise and understandable.

### BRIEF DESCRIPTION OF THE DRAWINGS

In order to better describe and illustrate the embodiments and/or examples of the present application disclosed herein, reference may be made to one or more of the accompanying drawings. The additional details or examples used to describe the accompanying drawings should not be considered a limitation on the scope of any of the disclosed applications, the embodiments and/or examples currently described, and the best mode of these applications as currently understood.

FIG. 1 is a structural schematic diagram of a solid-state electrolyte membrane structure in some embodiments of the present disclosure.

FIG. 2 is an XRD pattern of a solid-state electrolyte membrane in a second embodiment of the present disclosure.

In the figures,
10 represents a solid-state electrolyte membrane structure; 100 represents a solid-state electrolyte membrane; and 200 represents a substrate.

### DETAILED DESCRIPTION

The technical solutions in embodiments of the present disclosure will be clearly and completely described below in conjunction with the accompanying drawings in embodiments of the present disclosure. Obviously, the described embodiments are only a part of the embodiments of the present disclosure, but not all of the embodiments. Based on the embodiments in the present disclosure, all other embodiments obtained by a person of ordinary skill in the art without making creative labor fall within the scope of protection of the present disclosure.

Unless otherwise defined, all technical and scientific terms used in the specification of the present disclosure have the same meaning as commonly understood by those skilled in the art to which the present disclosure belongs. Terms used in the specification of the present disclosure are used only for the purpose of describing specific embodiments and are not intended to limit the present disclosure. The term “and/or” as used in the specification of the present disclosure includes any and all combinations of one or more of the relevant listed items.

A method for preparing a solid-state electrolyte membrane structure is provided in the present disclosure, which includes following steps:
step S1, proportionally mixing raw materials of a solid-state electrolyte to obtain a mixed powder;
step S2, mixing the mixed powder, a binder and a solvent together to obtain a solid-state electrolyte precursor slurry;
step S3, coating the solid-state electrolyte precursor slurry on a substrate to obtain a solid-state electrolyte precursor coating layer; and
step S4, subjecting the solid-state electrolyte precursor coating layer to a laser treatment to obtain the solid-state electrolyte membrane structure.

A method for preparing a solid-state electrolyte membrane structure is provided in the present disclosure. In the present disclosure, the solid-state electrolyte membrane structure includes a substrate and a solid-state electrolyte membrane fixed on the substrate.

In comparison to related art, in the present disclosure, raw materials of the solid-state electrolyte can directly prepare a solid-state electrolyte membrane structure on a substrate, so that a raw material cost is saved and steps of the method for preparing the solid-state electrolyte membrane structure is simplified. At the same time, in a solid-state electrolyte structure obtained in the present disclosure, the solid-state electrolyte membrane and the substrate are tightly combined, and the solid-state electrolyte member has a flat structure. The solid-state electrolyte membrane structure can be directly used in a following productive process, which facilitates improving a productive efficiency.

In some embodiments, the raw materials of the solid-state electrolyte includes a lithium source and a second metal source, and a second metal of the second metal source is selected from the group consisting of Al, Ti, Zr, La, Ta, Nb, and any combination thereof. A ratio described in the description “proportionally mixing raw materials of a solid-state electrolyte” is determined by contents of elements in a constitutional formula of a target solid-state electrolyte.

In some embodiments, the lithium source is selected from the group consisting of lithium salts, Li₂O, LiOH, and any combination thereof; and the second metal source is selected from the group consisting of second metal salts, second metal oxide, second metal hydroxide, and any combination thereof.

In some embodiments, the lithium source is selected from the group consisting of Li₂SO₄, LiNO₃, LiCl, Li₂O, LiOH, and any combination thereof; and the second metal source is selected from the group consisting of Al₂O₃, TiO₂, ZrO₂, La₂O₃, Ta₂O₅, Nb₂O₅, La(NO₃)₃, and any combination thereof.

In some embodiments, the raw materials of the solid-state electrolyte further includes a phosphorus source. In some embodiments, the phosphorus source includes but is not limited to a phosphate group. In some embodiments, the phosphate group may include but not limited to selected from the group consisting of NH₄H₂PO₄, (NH₄)₃PO₄, (NH₄)₂HPO₄, and any combination thereof.

In some embodiments, a ratio described in the description “proportionally mixing the lithium source, the second metal source and the phosphate sources” is determined by contents of elements in a constitutional formula of a target solid-state electrolyte. For example, when the constitutional formula of a target solid-state electrolyte is Li_{1.3}Al_{0.3}Ti_{1.7}P₃O₁₂, the lithium source can be Li₂CO₃, the second metal source can be Al₂O₃ and TiO₂, and phosphorus source can be NH₄H₂PO₄. A stoichiometric ratio of lithium (Li₂CO₃), the second metal source (Al₂O₃ or TiO₂), and the phosphorus source (NH₄H₂PO₄) can be calculated according to the constitutional formula of the target solid-state electrolyte Li_{1.3}Al_{0.3}Ti_{1.7}P₃O₁₂, and the target solid-state electrolyte can by produced by flexibly adjusting ratios of the raw materials.

In some embodiment, in step S1, proportionally mixing raw materials of the solid-state electrolyte to obtain the mixed powder includes: grinding and mixing the raw materials of the solid-state electrolyte, adding a dispersion medium, and grinding to obtain the mixed powder. An average particle size (as know as d50) of the mixed powder is smaller than or equal to 300 nm; optionally, the average particle size of the mixed powder is smaller than or equal to 200 nm; optionally, the average particle size of the mixed powder is smaller than or equal to 100 nm; optionally, the average particle size of the mixed powder is smaller than or equal to 50 nm; and optionally, the average particle size of the mixed powder is smaller than or equal to 20 nm. The smaller the particle size of the mixed powder is, the faster and more evenly the raw materials reacts.

In some embodiments, the grinding process may be but is not limited to methods such as ball-milling or sand-milling. In some embodiments, the dispersion medium is selected from the group consisting of ethanol, acetone, and any combination thereof. A time of the grinding is in a range of 5 h to 30 h; optionally, the time of the grinding is in a range of 8 h to 25 h; and optionally, the time of the grinding is in a range of 12 h to 20 h. After the grinding process, the dispersion medium is removed from the mixed raw materials of the solid-state electrolyte to obtain the mixed powder.

In some embodiments, in step S2, a mass ratio of the binder to the mixed powder is in a range of 1:100 to 5:95; optionally mass ratio of the binder to the mixed powder is 5:100; and optionally mass ratio of the binder to the mixed powder is 3:100. The binder is selected from the group consisting of polyvinylidene difluoride, epoxy resin, aramid, polytetrafluoroethylene, and any combination thereof. Adding the binder can prevent the solid-state electrolyte precursor coating layer from cracking after the solvent is dried, so as to provide a shaped and compact precursor coating layer having a suitable porosity for the laser treatment. An amount of the binder is related to the particle size of the mixed powder. The smaller the particle size of the mixed powder is, the greater a specific surface area of the mixed powder is, and the more binder is required. However, the binder may decompose under an action of a high temperature caused by the laser treatment, and generate holes. When the mass ratio of the binder to the mixed powder is greater than 5:95, large holes may be generated, which may lead to scattering. Accumulation of heat may lead to locally excessive heating, which is adverse to prepare an even and compact solid-state electrolyte membrane.

In some embodiments, in step S2, a viscosity of the solid-state electrolyte precursor slurry is in a range of 2000 cPs to 9000 cPs; optionally, the viscosity of the solid-state electrolyte precursor slurry is in a range of 2500 cPs to 8000 cPs; optionally, the viscosity of the solid-state electrolyte precursor slurry is in a range of 3000 cPs to 7000 cPs; and optionally, the viscosity of the solid-state electrolyte precursor slurry is in a range of 3500 cPs to 6000 cPs. In some embodiments, a mass ratio of the solvent to the mixed powder is in a range of 1:1 to 3:2, and the mass ratio of the solvent to the mixed powder is a general mass ratio for preparing a solution. The solvent is selected from the group consisting of ethanol, acetone, N-methylpyrrolidone, isopropanol, ethyl acetate, dimethylacetamide, and any combination thereof.

In the present disclosure, the mixed powder is mixed with the binder and the solvent to obtain the solid-state electrolyte precursor slurry, which facilitates mixing the raw materials of the solid-state electrolyte evenly. When the solid-state electrolyte mixed powder is directly burned with laser without preparing a slurry, the powder may fly off in the laser treatment.

In some embodiments, in step S3, the substrate includes a current collector or an electrode plate.

In some embodiments, in step S3, the substrate includes a negative current collector or a negative electrode plate including a negative active material layer. In some embodiments, the negative current collector is selected from the group consisting of copper, titanium-nickel alloy, nickel, and any combination thereof.

In some embodiments, in step S4, before the step of subjecting the solid-state electrolyte precursor coating layer to the laser treatment, further includes a step of subjecting the solid-state electrolyte precursor coating layer to a preheating treatment, a temperature of the preheating treatment is lower than a temperature at which the solid-state electrolyte precursor coating layer reacts, and a temperature difference between the temperature of the preheating treatment and the temperature at which the solid-state electrolyte precursor coating layer reacts is smaller than or equal to 400° C.

In the present disclosure, the preheating treatment can lower a thermal stress generated in the laser treatment. When the thermal stress is too great, a surface of the solid-state electrolyte membrane may bend and make the surface of the solid-state electrolyte membrane out of flatness, thereby affecting a character of service of the battery. When the temperature difference between the temperature of the preheating treatment and the temperature at which the raw materials of the solid-state electrolyte reacts is greater than 400° C., it is not easily to reduce the thermal stress. In addition, the preheating treatment can decompose materials that can easily generate gases, for example, the binder, the undried solvent, the materials easy to be decomposed, so as to prevent air bubbles from generating in a process of preparing the membrane by the laser treatment. It should be noted that elements required in the following reaction for preparing the membrane will be left after the raw materials of the solid-state electrolyte decomposed, and preparing of the product will not be affected.

In some embodiments, the temperature of the preheating treatment is in a range of 400° C. to 800° C.; optionally, the temperature of the preheating treatment is in a range of 450° C. to 750° C.; optionally, the temperature of the preheating treatment is in a range of 500° C. to 700° C.; optionally, the temperature of the preheating treatment is in a range of 550° C. to 650° C.; optionally, the temperature of the preheating treatment is 580° C.; and optionally, the temperature of the preheating treatment is 600° C.

In some embodiments, the preheating treatment is a gradient preheating treatment.

The gradient preheating treatment includes: heating the solid-state electrolyte precursor coating layer at a relatively low first heating rate to a temperature of decomposition of the binder and the raw materials of the solid-state electrolyte; holding at the temperature of decomposition of the binder and the raw materials of the solid-state electrolyte for a period of time; and after the binder and the raw materials of the solid-state electrolyte are completely decomposed, heating the solid-state electrolyte precursor coating layer at a higher second heating rate to the temperature of the preheating treatment. Thus, the thermal stress caused by the laser treatment can be lowered. Since an unduly great heating speed at the beginning may lead to instant decomposition and generate large holes, the solid-state electrolyte precursor coating layer is slowly heated before the binder and the raw materials of the solid-state electrolyte are decomposed.

It could be understood that the heating process of the preheating treatment is related to the temperatures of decomposition of the binder and the decomposable raw materials of the solid-state electrolyte. In some embodiments, the solid-state electrolyte precursor coating layer is heated at a lower first heating rate in a range of 1° C./min to 20° C./min to prevent large pores from generating caused by unduly great decomposition speed; optionally, the first heating rate is in a range of 3° C./min to 15° C./min; and optionally, the first heating rate is in a range of 5° C./min to 10° C./min. After the binder and the raw materials of the solid-state electrolyte are completely decomposed, the heating rate can be greater than 20° C./min; optionally, the heating rate is in a range of 20° C./min to 50° C./min; optionally, the heating rate is in a range of 25° C./min to 50° C./min; optionally, the heating rate is in a range of 20° C./min to 45° C./min; optionally, the heating rate is in a range of 20 to 40° C./min; optionally, the heating rate is in a range of 25° C./min to 40° C./min; and optionally, the heating rate is in a range of 30° C./min to 35° C./min.

In some embodiments, in step S4, after a temperature of the solid-state electrolyte precursor coating layer reaches the temperature of the preheating treatment, holding the solid-state electrolyte precursor coating layer for 1 minute to 10 minutes, and then subjecting the solid-state electrolyte precursor coating layer to the laser treatment. Optionally, a duration of the holding process is in a range of 3 minutes to 7 minutes; and optionally, the duration of the holding process is 5 minutes.

In some embodiments, the method for the preheating treatment includes preheating with an infrared oven or preheating with an electric resistance oven.

In some embodiments, before the step of subjecting the solid electrolyte precursor coating layer to the laser treatment, the method for preparing the solid-state electrolyte membrane structure further includes a step of drying the coating layer and applying a pressure to the coating layer. By drying the coating layer and applying a pressure to the coating layer, a porosity of the solid-state electrolyte precursor coating layer and a thickness of the solid-state electrolyte precursor coating layer can be controlled and adjusted.

It could be understood that the method for drying the solid-state electrolyte precursor coating layer includes but is not limited to drying with blower or drying with an oven, as long as the solvent in the solid-state electrolyte precursor coating layer can be dried, which are not limited herein. In the present disclosure, the method for applying a pressure to the solid-state electrolyte precursor coating layer includes but is not limited to rolling, as long as a porosity of the solid-state electrolyte precursor coating layer is in a range of 5% to 40% after applying the pressure to the solid-state electrolyte precursor coating layer; optionally, the porosity of the solid-state electrolyte precursor coating layer is in a range of 8% to 35%; optionally, the porosity of the solid-state electrolyte precursor coating layer is in a range of 10% to 30%; optionally, the porosity of the solid-state electrolyte precursor coating layer is in a range of 15% to 25%; and optionally, the porosity of the solid-state electrolyte precursor coating layer is in a range of 17% to 20%. When the porosity of the solid-state electrolyte precursor coating layer is greater than 40%, the laser may easily scatter after entering the solid-state electrolyte precursor coating layer, and the heat may easily accumulate, thereby leading to locally excessive heating. When the porosity of the solid-state electrolyte precursor coating layer is smaller than 5%, most of the laser will be reflected on the surface of the solid-state electrolyte precursor coating layer, and the heat may not be easily absorbed in the solid-state electrolyte precursor coating layer. Thus, reaction inside the solid-state electrolyte precursor coating layer cannot be sufficiently reacted, and it is difficult to prepare a solid-state electrolyte membrane having a high purity and a uniform structure.

In some embodiments, before the step of subjecting the solid electrolyte precursor coating layer to the laser treatment, a thickness of the solid-state electrolyte precursor coating layer is in a range of 5 μm to 100 μm; optionally, the thickness of the solid-state electrolyte precursor coating layer is in a range of 10 μm to 90 μm; optionally, the thickness of the solid-state electrolyte precursor coating layer is in a range of 15 μm to 80 μm; optionally, the thickness of the solid-state electrolyte precursor coating layer is in a range of 20 μm to 70 μm; optionally, the thickness of the solid-state electrolyte precursor coating layer is in a range of 25 μm to 60 μm; optionally, the thickness of the solid-state electrolyte precursor coating layer is in a range of 30 μm to 50 μm. When the thickness of the solid-state electrolyte precursor coating layer is smaller than 5 μm, difficulty of the foregoing coating process is increased. When the thickness of the solid-state electrolyte precursor coating layer is greater than 100 μm, the raw materials at the bottom of the solid-state electrolyte precursor coating layer is not easy to completely react. In the present disclosure, the thickness of the solid-state electrolyte precursor coating layer is a thickness of the solid-state electrolyte precursor coating layer after applying a pressure to the solid-state electrolyte precursor coating layer.

In some embodiments, in step S4, a wavelength of a laser for the laser treatment is in a range of 900 nm to 1200 nm; optionally, the wavelength of a laser for the laser treatment is in a range of 950 nm to 1150 nm; and optionally, the wavelength of a laser for the laser treatment is in a range of 1000 nm to 1100 nm. A power of the laser for the laser treatment is in a range of 20 W to 150 W; optionally, the power of the laser for the laser treatment is in a range of 30 W to 130 W; optionally, the power of the laser for the laser treatment is in a range of 50 W to 100 W; and optionally, the power of the laser for the laser treatment is in a range of 60 W to 90 W.

A scanning speed of the laser treatment can be set according to heat required by different raw materials for chemical reaction, light absorptivity of the material and wavelength characters of different devices. The scanning speed of the laser treatment can be in a range of 2000 mm/s to 5000 mm/s; optionally, the scanning speed of the laser treatment can be in a range of 2500 mm/s to 4500 mm/s; and optionally, scanning speed of the laser treatment can be in a range of 3000 mm/s to 4000 mm/s. A spot diameter of the laser treatment is in a range of 0.1 mm to 0.15 mm. A line spacing of the laser treatment is in a range of 0 to 0.075 mm. A defocusing distance is in a range of 0 to 200 mm; optionally, the defocusing distance is in a range of 5 to 150 mm; optionally defocusing distance is in a range of 10 to 100 mm; optionally defocusing distance is in a range of 20 to 80 mm; and optionally defocusing distance is in a range of 30 to 60 mm. The number of the laser scanning process is in a range of 5 to 50; optionally, the number of the laser scanning process is in a range of 10 to 40; and optionally, the number of the laser scanning process is in a range of 20 to 35.

In some embodiments, in step S4, a wavelength of a laser for the laser treatment is 1064 nm, a power of the laser for the laser treatment is in a range of 50 W to 150 W, a scanning speed of the laser treatment is in a range of 2000 mm/s to 5000 mm/s, a spot diameter of the laser treatment is in a range of 0.1 mm to 0.15 mm, a line spacing of the laser treatment is in a range of 0 to 0.075 mm, a defocusing distance is in a range of 0 to 200 mm, and the number of the laser scanning process is in a range of 5 to 50.

In the present disclosure, after the laser treatment, due to absorption characteristics of the material to the laser, the solid-state electrolyte precursor coating layer can be heated and react to prepare the solid-state electrolyte membrane in a shorter time, thereby improving the reaction efficiency. In addition, high temperature of the laser can melt the material on a surface of the metal substrate, so that the solid-state electrolyte membrane and the metal substrate can be tightly combined.

In some embodiments, after the step of obtaining the solid-state electrolyte membrane structure, the method for preparing the solid-state electrolyte membrane structure further includes repeating a step of coating the solid-state electrolyte precursor slurry on the solid-state electrolyte membrane to obtain the solid-state electrolyte precursor coating layer and a step of subjecting the solid-state electrolyte precursor coating layer to the laser treatment to accomplish a chemical reaction of the solid-state electrolyte precursor coating layer, so as to increase a thickness of the solid-state electrolyte membrane.

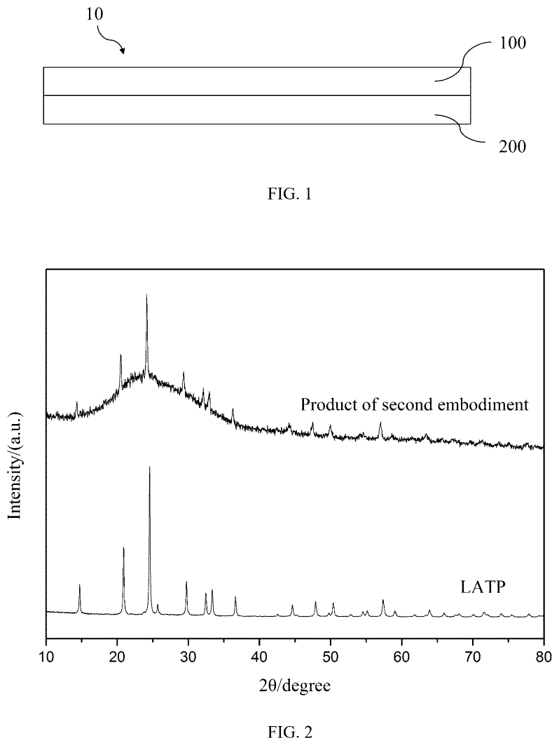

Referring to FIG. 1, the present disclosure further provides a solid-state electrolyte membrane structure 10, the solid-state electrolyte membrane structure 10 includes a solid-state electrolyte membrane 100 and a substrate 200.

In some embodiments, a material of the solid-state electrolyte membrane 100 prepared by the method in the present disclosure is selected from the group consisting of Li_{1.3}Al_{0.3}Ti_{1.7}P₃O₁₂ (LATP), Li₇La₃Zr₂O₁₂ (LLZO), Li_{6.4}La₃Zr_{1.4}Ta_{0.6}O₁₂ (LLZTO), Li_{6.5}La₃Zr_{1.5}Nb_{0.5}O₁₂ (LLZNO), Li_{6.8}La₃Zr_{1.6}Al_{0.6}O₁₂ (LLZAO), and any combination thereof.

In some embodiments, the substrate 200 is selected from a current collector or an electrode plate. In some embodiments, the substrate is selected from a negative current collector or a negative electrode plate including a negative active material layer. In some embodiments, a material of the substrate 200 is selected from the group consisting of copper, titanium-nickel alloy, nickel, and any combination thereof.

A method for preparing a solid-state electrolyte is further provided in the present disclosure, and the method for preparing the solid-state electrolyte includes the following steps:
step S1, proportionally mixing raw materials of a solid-state electrolyte to obtain a mixed powder;
step S2, mixing the mixed powder, a binder and a solvent together to obtain a solid-state electrolyte precursor slurry;
step S3, coating the solid-state electrolyte precursor slurry on a substrate to obtain a solid-state electrolyte precursor coating layer, drying, stripping the solid-state electrolyte precursor coating layer from the substrate and rolling to obtain a solid-state electrolyte precursor membrane;
step S4, subjecting the solid-state electrolyte precursor membrane to a laser treatment to obtain a solid-state electrolyte sheet; and
step S5, grinding the solid-state electrolyte sheet to obtain a solid-state electrolyte.

In some embodiments, in step S4, before subjecting the solid-state electrolyte precursor membrane to a laser treatment, the method for preparing the solid-state electrolyte further includes a step of subjecting the solid-state electrolyte precursor membrane to a preheating treatment.

The present disclosure further provides a solid-state electrolyte prepared by the method for preparing the solid-state electrolyte described above. The solid-state electrolyte includes but is not limited to Li_{1.3}Al_{0.3}Ti_{1.7}P₃O₁₂ (LATP), Li₇La₃Zr₂O₁₂ (LLZO), Li_{6.4}La₃Zr_{1.4}Ta_{0.6}O₁₂ (LLZTO), Li_{6.5}La₃Zr_{1.5}Nb_{0.5}O₁₂ (LLZNO) and Li_{6.8}La₃Zr_{1.6}Al_{0.6}O₁₂ (LLZAO).

### First Embodiment

Li₂CO₃, Al₂O₃, TiO₂ and NH₄H₂PO₄ were weighed to obtain a mixture, and a mole ratio of Li₂CO₃, Al₂O₃, TiO₂ and NH₄H₂PO₄ and was 0.65:0.15:1.7:3. Zirconium balls having a diameter of 0.2 mm and a dispersion medium of ethanol were added into the mixture, and subjected to sand grinding for 5 hours. When a particle size (d 50) of the resultant was 100 nm, the zirconium balls were separated from the mixture, the ethanol was dried, and the resultant was sieved to obtain a solid-state electrolyte precursor mixed powder.

The solid-state electrolyte precursor mixed powder and PVDF were weighed, and the mass ratio of the solid-state electrolyte precursor mixed powder and PVDF was 100:3. NMP was added into the resultant to obtain the solid-state electrolyte precursor slurry. The solid-state electrolyte precursor slurry was coated on a copper foil and dried to obtain a solid-state electrolyte precursor coating layer. A thickness of the solid-state electrolyte precursor coating layer was 70 μm. The solid-state electrolyte precursor coating layer was pressed compact, and a porosity of the solid-state electrolyte precursor coating layer was 20%. Then the solid-state electrolyte precursor coating layer-coated copper foil was subject to a laser scanning process to obtain a solid-state electrolyte membrane structure, and conditions of the laser scanning process were: a wavelength of the laser was 1064 nm, a power of the laser was 70 W, a scanning speed of the laser was 4000 mm/s, a spot diameter was 0.15 mm, a line spacing was 0.075 mm, a defocusing distance was 15 mm, and the number of the laser scanning process was 10. A material of the solid-state electrolyte membrane of the solid-state electrolyte membrane structure was Li_{1.3}Al_{0.3}Ti_{1.7}P₃O₁₂ (LATP).

### Second Embodiment

The differences between the first embodiment and the second embodiment were: before the laser scanning process, the solid-state electrolyte precursor coating layer-coated copper foil was placed in an infrared oven. A temperature in the infrared oven rose to 400° C. at a heating rate of 10° C./min, and held at 400° C. for 5 minutes. Then the solid-state electrolyte precursor coating layer-coated copper foil was subjected to the laser scanning process.

The solid-state electrolyte membrane of the solid-state electrolyte membrane structure was subject to XRD test. Referring to FIG. 2, the second embodiment can prepare Li_{1.3}Al_{0.3}Ti_{1.7}P₃O₁₂ (LATP) solid-state electrolyte having relatively high purity and a relatively intact structure. Conditions of the XRD test were: the scanning angle was 10° to 80°, the scanning speed was 10°/min, and the step size was 0.02°.

### Third Embodiment

The difference between the third embodiment and the second embodiment was a that a power of the laser scanning process was 10 W.

### Fourth Embodiment

Li₂CO₃, La₂O₃ and ZrO₂ were weighed and added into a mill pot, and a mole ratio of Li₂CO₃, La₂O₃ and ZrO₂ was 3.5:1.5:2. Zirconium balls and a dispersion medium of ethanol were added into the mill pot, and subjected to sand grinding for 5 hours. When a particle size (d 50) of the mixture was 300 nm, the zirconium balls were separated from the mixture, the ethanol was dried, and the resultant was filtered to obtain a solid-state electrolyte precursor mixed powder.

The solid-state electrolyte precursor mixed powder and a binder of epoxy resin were weighed, and the mass ratio of the solid-state electrolyte precursor mixed powder and the binder of epoxy resin was 95:5. Acetone was added into the resultant to obtain the solid-state electrolyte precursor slurry. The solid-state electrolyte precursor slurry was coated on a nickel sheet and dried to obtain a solid-state electrolyte precursor coating layer. A thickness of the solid-state electrolyte precursor coating layer was 10 μm. The solid-state electrolyte precursor coating layer was pressed compact, and a porosity of the solid-state electrolyte precursor coating layer was 5%. Then the solid-state electrolyte precursor coating layer-coated nickel sheet was placed in an infrared oven. A temperature in the infrared oven rose to 800° C. at a heating rate of 10° C./min, and held at 800° C. for 5 minutes. Then the solid-state electrolyte precursor coating layer-coated nickel sheet was subjected to the laser scanning process to obtain a solid-state electrolyte membrane structure, and conditions of the laser scanning process were: a power of the laser was 20 W, a scanning speed of the laser was 4000 mm/s, a spot diameter was 0.15 mm, a line spacing was 0.075 mm, a defocusing distance was 10 mm, and the number of the laser scanning process was 15. The solid-state electrolyte membrane of the solid-state electrolyte membrane structure was Li₇La₃Zr₂O₁₂ (LLZO).

### Fifth Embodiment

LiOH, La₂O₃, ZrO₂ and Ta₂O₅ were weighed and added into a mill pot, and a mole ratio of LiOH, La₂O₃, ZrO₂ and Ta₂O₅ was 6.4:1.5:1.4:0.3. Zirconium balls and a dispersion medium of ethanol were added into the mill pot, and subjected to sand grinding for 5 hours. When a particle size (d 50) of the mixture was 50 nm, the zirconium balls were separated from the mixture, the ethanol was dried, and the resultant was filtered to obtain a solid-state electrolyte precursor mixed powder.

The solid-state electrolyte precursor mixed powder and a binder of epoxy resin were weighed, and the mass ratio of the solid-state electrolyte precursor mixed powder and the binder of epoxy resin was 95:5. Acetone was added into the resultant to obtain the solid-state electrolyte precursor slurry. The solid-state electrolyte precursor slurry was coated on a nickel foil and dried to obtain a solid-state electrolyte precursor coating layer. A thickness of the solid-state electrolyte precursor coating layer was 100 μm. The solid-state electrolyte precursor coating layer was pressed compact, and a porosity of the solid-state electrolyte precursor coating layer was 30%. Then the solid-state electrolyte precursor coating layer-coated nickel foil was placed in an infrared oven. A temperature in the infrared oven rose to 400° C. at a heating rate of 10° C./min, then rose to 800° C. at a heating rate of 25° C./min, and held at 800° C. for 5 minutes. Then the solid-state electrolyte precursor coating layer-coated nickel foil was subjected to the laser scanning process to obtain a solid-state electrolyte membrane structure, and conditions of the laser scanning process were: a power of the laser was 150 W, a scanning speed of the laser was 4000 mm/s, a spot diameter was 0.15 mm, a line spacing was 0.075 mm, a defocusing distance was 20 mm, and the number of the laser scanning process was 15. The solid-state electrolyte membrane of the solid-state electrolyte membrane structure was Li_{6.4}La₃Zr_{1.4}Ta_{0.6}O₁₂ (LLZTO).

It could be concluded from the first embodiment to the third embodiment that a solid-state electrolyte membrane of Li_{1.3}Al_{0.3}Ti_{1.7}P₃O₁₂ (LATP) having a intact structure can be prepared on a metal foil. In some embodiments, since the LATP solid-state electrolyte membrane cannot directly contact with a lithium negative electrode plate, another kind of solid-state electrolyte membrane (for example, an LLZO solid-state electrolyte membrane) should be disposed between the LATP solid-state electrolyte membrane and the nickel sheet. That is, a layer of LLZO solid-state electrolyte membrane can be firstly prepared on the nickel sheet by the method in the present disclosure, and then a LATP solid-state electrolyte membrane can be prepared on the LLZO solid-state electrolyte membrane by the method in the present disclosure.

The technical features of the above to mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above to described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A method for preparing a solid-state electrolyte membrane structure, comprising
step S1, proportionally mixing raw materials of a solid-state electrolyte to obtain a mixed powder;
step S2, mixing the mixed powder, a binder and a solvent together to obtain a solid-state electrolyte precursor slurry;
step S3, coating the solid-state electrolyte precursor slurry on a substrate to obtain a solid-state electrolyte precursor coating layer; and
step S4, subjecting the solid-state electrolyte precursor coating layer to a laser treatment to obtain the solid-state electrolyte membrane structure.

2. The method of claim 1, wherein the raw materials of the solid-state electrolyte comprises a lithium source and a second metal source, and a second metal of the second metal source is selected from the group consisting of Al, Ti, Zr, La, Ta, Nb, and any combination thereof.

3. The method of claim 2, wherein the lithium source is selected from the group consisting of lithium salts, Li₂O, LiOH, and any combination thereof; and the second metal source is selected from the group consisting of second metal salts, second metal oxide, second metal hydroxide, and any combination thereof.

4. The method of claim 2, wherein the lithium source is selected from the group consisting of Li₂SO₄, LiNO₃, LiCl, Li₂O, LiOH, and any combination thereof; and the second metal source is selected from the group consisting of Al₂O₃, TiO₂, ZrO₂, La₂O₃, Ta₂O₅, Nb₂O₅, La(NO₃)₃, and any combination thereof.

5. The method of claim 2, wherein the raw materials of the solid-state electrolyte further comprises a phosphorus source, the phosphorus source comprises a phosphate group, the phosphate group is selected from the group consisting of NH₄H₂PO₄, (NH₄)₃PO₄, (NH₄)₂HPO₄, and any combination thereof.

6. The method of claim 1, wherein in step S1, proportionally mixing raw materials of the solid-state electrolyte to obtain the mixed powder comprises grinding the raw materials of the solid-state electrolyte to obtain the mixed powder, and an average particle size of the mixed powder is smaller than or equal to 300 nm.

7. The method of claim 1, wherein in step S2, a mass ratio of the binder to the mixed powder is in a range of 1:100 to 5:95.

8. The method of claim 1, wherein in step S2, a viscosity of the solid-state electrolyte precursor slurry is in a range of 2000 cPs to 9000 cPs.

9. The method of claim 1, wherein in step S3, the substrate comprises a current collector or an electrode plate.

10. The method of claim 1, wherein step S4, before the step of subjecting the solid-state electrolyte precursor coating layer to the laser treatment, further comprises a sstep of subjecting the solid-state electrolyte precursor coating layer to a preheating treatment, a temperature of the preheating treatment is lower than a temperature at which the solid-state electrolyte precursor coating layer reacts chemically, and a temperature difference between the temperature of the preheating treatment and the temperature at which the solid-state electrolyte precursor coating layer reacts chemically is smaller than or equal to 400° C.

11. The method of claim 10, wherein the temperature of the preheating treatment is in a range of 400° C. to 800° C.

12. The method of claim 10, wherein the preheating treatment is a gradient preheating treatment.

13. The method of claim 12, wherein the gradient preheating treatment comprises: heating the solid-state electrolyte precursor coating layer at a first heating rate in a range of 1° C./min to 20° C./min, and then heating the solid-state electrolyte precursor coating layer at a second heating rate in a range of 20° C./min to 50° C./min to the temperature of the preheating treatment.

14. The method of claim 10, wherein step S4, after a temperature of the solid-state electrolyte precursor coating layer reaches the temperature of the preheating treatment, holding the solid-state electrolyte precursor coating layer for 1 minute to 10 minutes, and then subjecting the solid-state electrolyte precursor coating layer to the laser treatment.

15. The method of claim 1, wherein step S4, before the step of subjecting the solid electrolyte precursor coating layer to the laser treatment, further comprises a step of drying the solid-state electrolyte precursor coating layer and applying a pressure to the solid-state electrolyte precursor coating layer.

16. The method of claim 1, wherein in step S4, before the step of subjecting the solid electrolyte precursor coating layer to the laser treatment, a porosity of the solid-state electrolyte precursor coating layer is in a range of 5% to 40%.

17. The method of claim 1, wherein in step S4, before the step of subjecting the solid electrolyte precursor coating layer to the laser treatment, a thickness of the solid-state electrolyte precursor coating layer is in a range of 5 μm to 100 μm.

18. The method of claim 1, wherein in step S4, a wavelength of a laser for the laser treatment is in a range of 900 nm to 1200 nm, and a power of the laser for the laser treatment is in a range of 20 W to 150 W.

19. The method of claim 1, wherein in step S4, the solid-state electrolyte structure comprises the substrate and a solid-state electrolyte membrane fixed on the substrate;
after the step of obtaining the solid-state electrolyte membrane structure, the method further comprises repeating a step of coating the solid-state electrolyte precursor slurry on the solid-state electrolyte membrane to obtain the solid-state electrolyte precursor coating layer and a step of subjecting the solid-state electrolyte precursor coating layer to the laser treatment to accomplish a chemical reaction of the solid-state electrolyte precursor coating layer, so as to increase a thickness of the solid-state electrolyte membrane.
